(19) United States
(12) Patent Application Publication
(10) Pub. No.: US 2026/0269135 A1
(43) Pub. Date: Sep. 10, 2026

(54) MULTILAYER CERAMIC ELECTRONIC COMPONENT, AND METHOD FOR MANUFACTURING MULTILAYER CERAMIC ELECTRONIC COMPONENT

(71) Applicant: TAIYO YUDEN CO., LTD., Tokyo (JP)

(72) Inventors: Masumi ISHII, Tokyo (JP); Michio OSHIMA, Tokyo (JP); Yoshimasa KITAMURA, Tokyo (JP); Toshihiro FUKUDA, Tokyo (JP); Kiyoshiro YATAGAWA, Tokyo (JP)

(21) Appl. No.: 19/555,279

(22) Filed: Mar. 3, 2026

(30) Foreign Application Priority Data
Mar. 5, 2025 (JP) 2025-034736

(51) Int. Cl. H01G 4/30; H01G 4/008

(52) U.S. Cl. CPC H01G 4/30; H01G 4/0085

(57) ABSTRACT

Multilayer ceramic electronic component includes: base body including plurality of dielectric layers laminated in first direction and plurality of internal electrode layers positioned between dielectric layers, the base body having pair of end surfaces facing each other in second direction orthogonal to first direction and pair of side faces facing each other in third direction orthogonal to first and second directions, plurality of internal electrode layers being exposed to one and other of pair of end surfaces; and external electrodes disposed on pair of end surfaces, respectively. Base body includes end margin parts in which internal electrode layers exposed to same end surface face each other via none of internal electrode layers exposed to different end surface. In end margin parts, plurality of internal electrode layers include: bent portion bent in first direction; and heterogenous phase in contact with bent portion, composed of material different from plurality of dielectric layers.

### CROSS-REFERENCE TO RELATED APPLICATION

The present application claims priority under 35 U.S.C. §119 to Japanese Patent Application No. 2025-034736, filed March 5, 2025, the contents of which are incorporated herein by reference in their entireties.

### BACKGROUND OF THE INVENTION

### Field of the Invention

The present disclosure relates to a multilayer ceramic electronic component and a method for manufacturing a multilayer ceramic electronic component.

### Description of the Related Art

Multilayer ceramic electronic components, such as a multilayer ceramic capacitor (MLCC), and the like, include: an approximately rectangular parallelepiped base body including a plurality of laminated dielectric layers and a plurality of internal electrode layers positioned between the plurality of dielectric layers; and external electrodes provided on a pair of end surfaces of the base body, and have a structure in which the plurality of internal electrode layers are extracted to be exposed alternately to one and the other of a pair of end surfaces of the base body.

In manufacture of a multilayer ceramic electronic component, for example, as disclosed in Japanese Patent Application Laid-Open Publication No. 2015-111650, it is known that a base body is manufactured by laminating a plurality of ceramic green sheets in which internal electrode patterns are formed, compression-bonding the plurality of ceramic green sheets in the lamination direction to obtain a mother ceramic laminate, and singulating and firing the laminate. A multilayer ceramic electronic component using the base body manufactured in this way includes: end margin parts that are extraction regions in which dielectric layers are extracted to end surfaces and that include internal electrode layers exposed to one end surface or internal electrode layers exposed to the other end surface; and side margin parts in which the dielectric layers are extracted to side surfaces and that include no internal electrode layers.

### SUMMARY OF THE INVENTION

Since an end margin part does not include, among the internal electrode layers, internal electrode layers that are exposed to one end surface or to the other end surface, the end margin part has a density less than that of a capacitive part in which the internal electrode layers exposed to one end surface and the internal electrode layers exposed to the other end surface overlap. Therefore, the internal electrode layers in the end margin parts are easily deformed when they are subjected to external forces in the process of lamination and singulation, and, for example, may be bent in the lamination direction, resulting in formation of a bent portion. Further, along with the formation of the bent portion, a void is formed in contact with the bent portion. Such a void can be the cause of defects, such as delamination and the like.

It is an object of the present disclosure to provide a multilayer ceramic electronic component that has reduced defects particularly in the end margin parts, and a method for manufacturing a multilayer ceramic electronic component.

According to one embodiment of the present disclosure, a multilayer ceramic electronic component includes: a base body including a plurality of dielectric layers laminated in a first direction and a plurality of internal electrode layers positioned between the plurality of dielectric layers, the base body having a pair of end surfaces facing each other in a second direction orthogonal to the first direction, and a pair of side faces facing each other in a third direction orthogonal to the first direction and the second direction, the plurality of internal electrode layers being exposed to one and the other of the pair of end surfaces; and external electrodes disposed on the pair of end surfaces, respectively, wherein the base body includes end margin parts in which the internal electrode layers exposed to a same end surface face each other via none of the internal electrode layers exposed to a different end surface, and wherein in the end margin parts, the plurality of internal electrode layers include: a bent portion that is bent in the first direction; and a heterogenous phase that is composed of a material different from that of the plurality of dielectric layers and is in contact with the bent portion.

According to the present disclosure, it is possible to reduce defects particularly in the end margin parts.

### BRIEF DESCRIPTION OF THE DRAWINGS

FIG. 1 is an oblique view of a multilayer ceramic electronic component according to an embodiment;

FIG. 2 is a cross-sectional view taken along a line A-A' in FIG. 1;

FIG. 3 is a cross-sectional view taken along a line B-B' in FIG. 1;

FIG. 4 is an enlarged view of a part C in FIG. 2;

FIG. 5 is a view corresponding to FIG. 4, showing a state in which voids are not filled;

FIG. 6 is a flowchart illustrating a method for manufacturing a multilayer ceramic electronic component according to an embodiment;

FIG. 7 is a view illustrating a method for manufacturing a multilayer ceramic electronic component according to an embodiment;

FIG. 8 is a view illustrating a method for manufacturing a multilayer ceramic electronic component according to an embodiment;

FIG. 9 is a view illustrating a method for manufacturing a multilayer ceramic electronic component according to an embodiment;

FIG. 10 is a view illustrating a method for manufacturing a multilayer ceramic electronic component according to an embodiment; and

FIG. 11 is a flowchart illustrating a method for manufacturing a multilayer ceramic electronic component according to a modified example.

### DETAILED DESCRIPTION OF THE DISCLOSURE

An embodiment of the present disclosure will be described in detail below. However, the present disclosure is not limited thereto. In the present specification and the drawings, components having substantially the same functional configuration are denoted by the same reference numerals, thereby omitting redundant descriptions. The drawings show three axes defining a fixed coordinate system fixed to a multilayer ceramic electronic component, that is, an X-axis, a Y-axis, and a Z-axis orthogonal to each other. In the present specification, a second direction along the X-axis is also referred to as an X-axis direction, a third direction along the Y-axis is also referred to as a Y-axis direction, and a first direction along the Z-axis is also referred to as a Z-axis direction (first direction).

### Structure of Multilayer Ceramic Capacitor

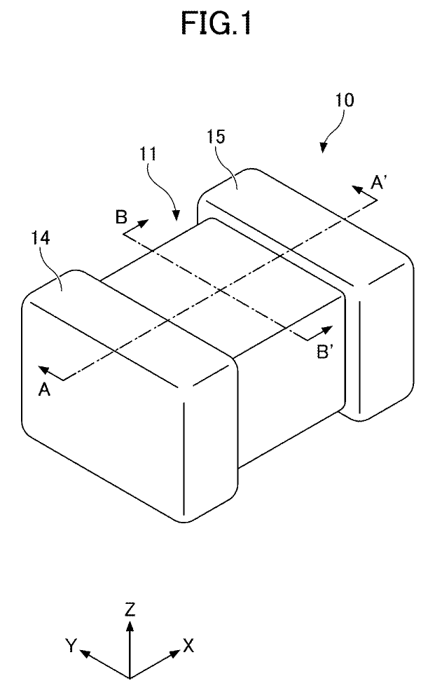

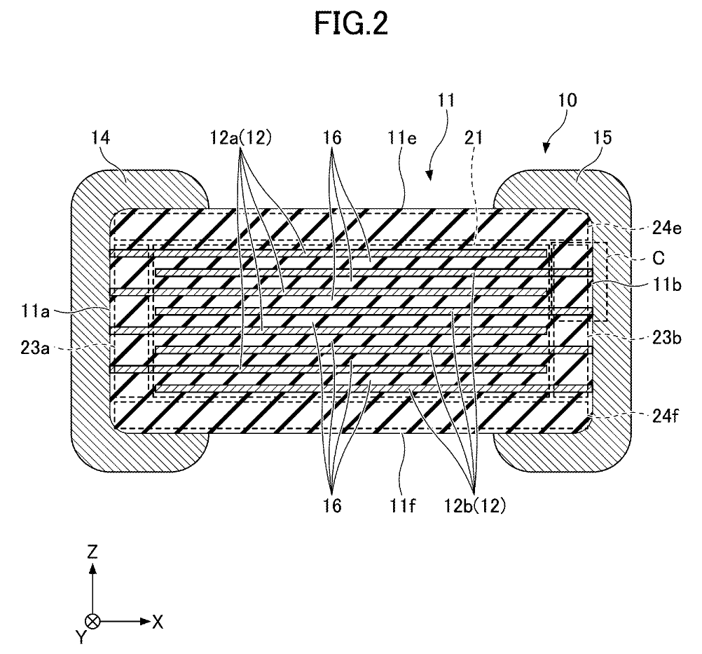

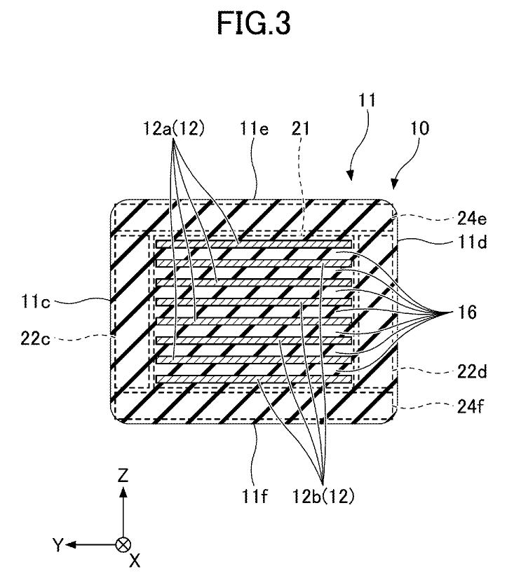

Hereinafter, a multilayer ceramic capacitor will be described as an embodiment of a multilayer ceramic electronic component. FIG. 1 is an oblique view showing a multilayer ceramic capacitor 10. FIG. 2 is a cross-sectional view taken along a line A-A′ in FIGS. 1 and 3 is a cross-sectional view taken along a line B-B′ in FIG. 1. In FIGS. 2 and 3, voids and heterogenous phases formed in side margin parts, which will be described later, are not shown.

The multilayer ceramic capacitor 10 according to an embodiment includes a base body 11, which is a ceramic base body, a first external electrode 14, and a second external electrode 15. The surface of the base body 11 includes a first end surface 11a and a second end surface 11b that face each other typically in the X-axis direction, a first side surface 11c and a second side surface 11d that face each other typically in the Y-axis direction, and a first main surface 11e and a second main surface 11f that face each other typically in the Z-axis direction. More specifically, the first end surface 11a faces one side in the X-axis direction, and the second end surface 11b faces the other side in the X-axis direction. The first side surface 11c faces one side parallel with the Y-axis direction, and the second side surface 11d faces the other side in the Y-axis direction. The first main surface 11e faces one side in the Z-axis direction, and the second main surface 11f faces the other side in the Z-axis direction. The first end surface 11a and the second end surface 11b extend along the Y-axis direction and the Z-axis direction, that is, along the Y-Z plane. The first side surface 11c and the second side surface 11d extend along the Z-axis direction and the X-axis direction, that is, along the X-Z plane. The first main surface 11e and the second main surface 11f extend along the X-axis direction and the Y-axis direction, that is, along the X-Y plane.

All of the first end surface 11a, the second end surface 11b, the first side surface 11c, the second side surface 11d, the first main surface 11e, and the second main surface 11f of the base body 11 are formed as flat surfaces. A flat surface in the present embodiment does not need to be a strictly flat surface as long as it is recognized as flat when viewed as a whole, and includes, for example, a surface having minute uneven shapes, gently curved shapes, and the like.

The base body 11 includes ridge parts connecting the first end surface 11a, the second end surface 11b, the first side surface 11c, the second side surface 11d, the first main surface 11e, and the second main surface 11f with each other. The ridge parts are chamfered and rounded in the illustrated example, but do not need to be chamfered.

The base body 11 has a structure in which dielectric layers 16 and internal electrode layers 12 are laminated alternately in the Z-axis direction. More specifically, the internal electrode layers 12 include first internal electrode layers 12a extracted to be exposed to the first end surface 11a and second internal electrode layers 12b extracted to be exposed to the second end surface 11b, and the first internal electrode layers 12a and the second internal electrode layers 12b are arranged alternately in the Z-axis direction. Thus, the base body 11 includes a plurality of dielectric layers 16 laminated in the Z-axis direction, and a plurality of first internal electrode layers 12a and a plurality of second internal electrode layers 12b located between the plurality of dielectric layers 16. All of the dielectric layers 16, and the first internal electrode layers 12a and the second internal electrode layers 12b have a sheet-like shape extending along the X-Y plane (in a direction orthogonal to the Z-axis direction).

The base body 11 includes a capacitive part 21, which is a region in which the first internal electrode layers 12a and the second internal electrode layers 12b face each other in the Z-axis direction via the dielectric layers 16, that is, a region in which the first internal electrode layers 12a and the second internal electrode layers 12b overlap each other via the dielectric layers 16 when viewed in the Z-axis direction. The capacitive part 21 is a region in which electric capacitance is generated in the multilayer ceramic capacitor 10. As shown in FIG. 2, the first internal electrode layers 12a extracted from the capacitive part 21 to the first end surface 11a are connected to the first external electrode 14, and the second internal electrode layers 12b extracted from the capacitive part 21 to the second end surface 11b are connected to the second external electrode 15.

In addition to the capacitive part 21, the base body 11 includes a pair of side margin parts 22c and 22d, a pair of end margin parts 23a and 23b, and a pair of cover parts 24e and 24f.

As shown in FIG. 3, the side margin part 22c is provided on the +Y direction side of the capacitive part 21, that is, on the +Y side, and the side margin part 22d is provided on the −Y direction side of the capacitive part 21, that is, on the −Y side. The side margin part 22c is a region including the first side surface 11c and constituting a region that is on the +Y side of the +Y-side outer ends of the first internal electrode layers 12a and the second internal electrode layers 12b. The side margin part 22d is a region including the second side surface 11d and constituting a region that is on the −Y side of the −Y-side outer ends of the first internal electrode layers 12a and the second internal electrode layers 12b. In the present embodiment, the side margin parts 22c and 22d are regions in which the internal electrode layers 12 are not extracted, and are regions in which the plurality of dielectric layers 16 are laminated in the Z direction via no internal electrode layers 12. That is, the side margin parts 22c and 22d do not include the internal electrode layers 12.

As shown in FIG. 2, the end margin part 23a is provided on the −X direction side of the capacitive part 21, that is, on the −X side, and the end margin part 23b is provided on the +X direction side of the capacitive part 21, that is, on the +X side. The end margin part 23a is provided on the outer side of the second internal electrode layers 12b in the X direction, and constitutes the first end surface 11a. The end margin part 23a includes parts of the first internal electrode layers 12a, but does not include the second internal electrode layers 12b. The end margin part 23b is provided on the outer side of the first internal electrode layers 12a in the X direction and constitutes the second end surface 11b. The end margin part 23b includes parts of the second internal electrode layers 12b, but does not include the first internal electrode layers 12a.

The cover part 24e is provided on the +Z side of the capacitive part 21, the side margin parts 22c and 22d, and the end margin parts 23a and 23b, and the cover part 24f is provided on the −Z side of the capacitive part 21, the side margin parts 22c and 22d, and the end margin parts 23a and 23b. The cover parts 24e and 24f do not include the first internal electrode layers 12a and the second internal electrode layers 12b. The cover parts 24e and 24f may be composed of the same material as that of the dielectric layers 16.

The first external electrode 14 is disposed on the surface of the base body 11, and, for example, covers the first end surface 11a. The second external electrode 15 is disposed on the surface of the base body 11, and, for example, covers the second end surface 11b. The first external electrode 14 and the second external electrode 15 face each other in the X direction across the base body 11, and function as terminals of the multilayer ceramic capacitor 10.

In the base body 11, a dielectric ceramic having a high dielectric constant is used as the material of the dielectric layers 16 in order to increase the capacity of each dielectric layer 16 in the capacitive part 21. That is, the main component of the dielectric layers 16 in the present embodiment may be a dielectric ceramic, preferably a dielectric ceramic having a high dielectric constant. Examples of the dielectric ceramic having a high dielectric constant include a material having a perovskite structure including barium (Ba) and titanium (Ti), represented by barium titanate (BaTiO₃).

The dielectric ceramic may be a compositional system, such as strontium titanate (SrTiO₃), calcium titanate (CaTiO₃), magnesium titanate (MgTiO₃), calcium zirconate (CaZrO₃), calcium zirconate titanate (Ca(Zr, Ti)O₃), barium zirconate (BaZrO₃), titanium oxide (TiO₂), and the like.

In the multilayer ceramic capacitor 10, when a voltage is applied to the first external electrode 14 and the second external electrode 15, the voltage is applied to the plurality of internal electrode layers 12 in the capacitive part 21. Thus, in the multilayer ceramic capacitor 10, charges corresponding to the voltage are stored between the first internal electrode layers 12a and the second internal electrode layers 12b.

The first external electrode 14 and the second external electrode 15 may be composed of a good electric conductor. Examples of the good conductors for forming the first external electrode 14 and the second external electrode 15 include metals or alloys of which the main component is nickel (Ni), copper (Cu), tin (Sn), palladium (Pd), platinum (Pt), silver (Ag), gold (Au), and the like. In this specification, the term “main component ” refers to a component having the highest content ratio. Therefore, for example, when the text reads that “a predetermined element is the main component”, it means that the atm% of the predetermined element is the highest.

The first internal electrode layers 12a and the second internal electrode layers 12b are also composed of a good conductor. Examples of the good conductor for forming the first internal electrode layers 12a and the second internal electrode layers 12b typically include nickel (Ni), as well as metals or alloys containing copper (Cu), palladium (Pd), platinum (Pt), silver (Ag), gold (Au), and the like as the main component.

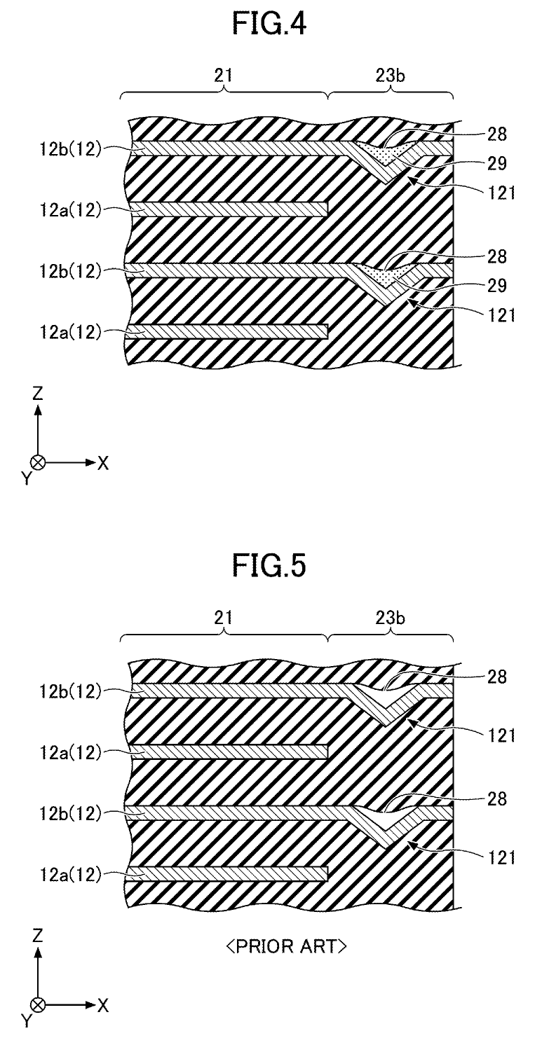

FIG. 4 is a schematic enlarged view of a part C in FIG. 2. FIG. 4 illustrates one end margin part 23b of the two end margin parts, and the following description mainly describes the configuration of the end margin part 23b. However, the end margin part 23a has a similar configuration.

As shown in FIG. 4, the second internal electrode layers 12b extracted to the end margin part 23b have bent portions 121 that are bent in the Z direction. In the example shown in FIG. 4, the bent portions 121 are bent in the -Z direction. However, the bent portions 121 may be bent in the +Z direction. The bent portions 121 are formed in one or more of the plurality of second internal electrode layers 12b, and may be formed in all of the second internal electrode layers 12b.

In the end margin part 23b, a heterogenous phase 29 is formed in contact with the bent portions 121. More specifically, voids 28 in contact with the bent portions 121 of the second internal electrode layers 12b are formed in the end margin part 23b, and the voids 28 are filled with the heterogenous phase 29. The voids 28 themselves refer to parts formed in the end margin part 23b and free of the dielectric material.

The bent portions 121 of the internal electrode layers 12 extracted to the end margin part 23b might form due to receiving a force in the Z direction from the outside in a lamination step (S3) and a singulation step (S4) during manufacture of the multilayer ceramic capacitor 10. Along with the formation of the bent portions 121, the voids 28 are formed on a side opposite to the side to which the bent portions 121 are bent. FIG. 5 shows a partial cross-sectional view corresponding to FIG. 4 and including the end margin part 23b including the voids 28 that are not filled with a material and are empty. FIG. 5 shows a partial cross-sectional view including the end margin part 23b of a multilayer ceramic capacitor corresponding to the prior art. In the configuration including the bent portions 121 in the internal electrode layers 12 and the voids 28 that are not filled as shown in FIG. 5, stress tends to concentrate around the voids 28, to form starting points of defects, such as cracks, delamination, and the like, which may deteriorate the reliability of the multilayer ceramic electronic component. In addition, a recent demand for an increased capacitance density in the multilayer ceramic electronic component and the like have been requiring that a large number of layers should be laminated. Thus, reduction in the thickness of the internal electrode layers 12 has been promoted, making the bent portions 121 more likely to be formed in the end margin part. Furthermore, due to an increase in the electrostrictive stress in accordance with the up-rating and the like, even a void 28 that has a size that has been considered to not affect the reliability in the past has become no longer ignorable.

On the other hand, in the present embodiment, as shown in FIG. 4, the voids 28 are filled with the heterogenous phase 29. Therefore, stress that might otherwise be generated around the empty voids 28 as described above can be inhibited, and defects, such as cracks, delamination, and the like can be reduced. By reducing defects in the end margin part 23b in this way, it is possible to inhibit failures of the multilayer ceramic capacitor 10. Therefore, it is possible to improve moisture resistance, impact resistance, and the like in a multilayer ceramic electronic component that is adapted to recent trends, such as an increase in the capacity density, up-rating, and the like.

As shown in FIG. 4, the bent portions 121 may be recessed portions that are recessed to the +Z side or to the −Z side, that is, projecting portions that project to the +Z side or to the −Z side when viewed in a cross-section cut along the X-Z plane. Here, the “recessed portion” is a portion that is dented in one direction with respect to the portions on both sides thereof, and the “projecting portion” is a portion that projects in one direction with respect to the portions on both sides thereof. In other words, the recessed portion is a portion of which the tangent line has a slope that changes from negative to positive, and the projecting portion is a portion of which the tangent line has a slope that changes from positive to negative. In this case, the change in the slope of the tangent line of the shape of the bent portions 121 may be continuous; for example, the bent portions 121 may be portions curved in a curved shape. The change in the slope of the tangent line of the shape of the bent portions 121 may be discontinuous; for example, the bent portions 121 may have a shape bent to have a sharp corner.

The bent portions 121 may be portions that are continuous in the Y direction. For example, the bent portions 121 may be continuous in the Y direction from one side surface 11c to the other side surface 11d. Thus, when viewed three-dimensionally, the bent portions 121 may be groove-shaped portions dented in one or the other direction in the Z direction, or ridge-shaped portions projecting in one or the other direction in the Z direction.

Further, although the bent portions 121 are bent in the Z direction when viewed in a cross-section cut along the X and Z directions, they may be portions that are bent in the Z direction when viewed in a cross-section cut along the Y and Z directions. Further, they may be portions that are bent in the Z direction both when viewed in a cross-section cut along the X and Z directions and when viewed in a cross-section cut along the Y and Z directions.

A part of each void 28 is surrounded by the bent portion 121 of the second internal electrode layer 12b, and the remaining part is surrounded by the dielectric layer 16. Therefore, the shape of each void 28 on one side in the Z direction corresponds to the shape of the bent portion 121. Therefore, the cross-sectional shape of each void 28 when viewed in a cross-section cut along the X and Z directions may be a shape that projects to the −Z side or to the +Z side, in accordance with a range in contact with the bent portion 121 of the internal electrode layer 12.

Further, since each bent portion 121 has a continuous groove or ridge shape as described above, each void 28 also has an elongated shape. The longitudinal direction of the voids 28 is along the Y direction. In this specification, the phrase “along a predetermined direction” encompasses not only a case where a direction is completely parallel with the predetermined direction, but also a case where a direction is inclined by preferably 10° and more preferably 5° from the predetermined direction.

The equivalent circle diameter of the cross-section of each void 28 cut in the X and Z directions is preferably 0.1 μm or greater and 10 μm or less, and more preferably 0.2 μm or greater and 2 μm or less. Here, the equivalent circle diameter refers to the diameter of a circle having the same area as that of the cross-section of the void 28 cut in the X and Z directions.

The length of each void 28 in the Y direction may be equal to or greater than 3 times, and more preferably equal to or greater than 5 times the equivalent circle diameter of the cross-section of the void 28 cut in the X and Z directions. When there is a distribution in the dimensions of the voids 28 included in the end margin part, the above-specified dimensions are the average values.

As described above, the voids 28 are cavity portions different from micropores that have a small volume and may exist in the dielectric layers 16.

The heterogenous phase 29 filling the voids 28 is composed of a material different from that of the dielectric layers 16. More specifically, the heterogenous phase 29 is a layer containing a main component different from the main component of the dielectric layers 16, that is, the heterogenous phase 29 is a phase in which the main component is not the dielectric ceramic, which is the main component of the dielectric layers 16.

In the example shown in FIGS. 4 and 5, the entire volume of each void 28 is filled with the heterogenous phase 29. However, the void 28 may be partially filled with the heterogenous phase 29, that is, a part of the entire volume of the void 28 may be filled with the heterogenous phase 29 and another part may be an unfilled portion that is not filled with the heterogenous phase 29. From the viewpoint of inhibiting stress concentration and reducing defects, it is more preferable that the entire void 28 is filled with the heterogenous phase 29.

In the example shown in FIG. 4, the bent portions 121 include recessed portions that are recessed to the -Z side when viewed in a cross-section cut at least in the X and Z directions. The heterogenous phase 29 is formed to contact the bottom in the recessed portions of the bent portions 121, preferably to contact the entirety of the bottom. The bottom of the recessed portion of each bent portion 121 bent in the Z direction refers to a portion that is located at a position that is farthest in the Z direction from a part of the internal electrode layer 12 at which no recessed portion exists. As shown in FIG. 4, the bottom of the recessed portion may be a point or a line when viewed in a cross-section cut in the X-Z plane. The heterogenous phase 29 may be formed to fill the entirety of the recessed portion of the bent portion 121.

When the entirety of a void 28 is completely filled with the heterogenous phase 29 as in the example shown in FIG. 4, the shape and size of the void 28 are substantially the same as the shape and size of the heterogenous phase 29. Therefore, the equivalent circle diameter of a cross-section of the heterogenous phase 29 cut in the X and Z directions may preferably be 0.1 μm or greater and 10 μm or less, and more preferably 0.2 μm or greater and 2 μm or less.

The length of the heterogenous phase 29 in the Y direction may be equal to or greater than 3 times, and more preferably equal to or greater than 5 times the equivalent circle diameter of the cross-section of the heterogenous phase 29 cut in the X and Z directions. When there is a distribution in the dimensions of the heterogenous phase 29 included in the end margin part, the above-specified dimensions are the average values.

The main component of the heterogenous phase 29 may be a glass phase. The heterogenous phase 29, of which the main component is a glass phase, precipitates as a liquid during sintering of the dielectric layers 16 and fills the voids 28 along the shape of the voids 28. Further, since the heterogenous phase 29 is not a conductor, the heterogenous phase 29 does not electrically affect the internal electrode layers 12. It is preferable that the heterogenous phase 29 is composed of a glass phase. The composition of the glass phase is not particularly limited as long as it contains silicon (Si). Yet, it is preferable that the glass phase contains silicon (Si) and aluminum (Al).

More specifically, the glass phase may contain an oxide of a metal or a metalloid, and may contain at least SiO₂. In addition to SiO₂, the glass phase may contain one or more oxides selected from Al₂O₃, B₂O₃, MgO, MnO_{2,} CaO, SrO, Na₂O, K₂O, Fe₂O₃, FeO, ZrO₂, Li₂O, ZnO, PbO, As₂O₃, and Sb₂O₃.

When the heterogenous phase 29 contains silicon, the concentration of silicon in the heterogenous phase 29 is preferably 1atm% or greater and 50atm% or less, and more preferably 5atm% or greater and 50atm% or less.

The heterogenous phase 29 may contain a material other than the glass phase. For example, a small amount of dielectric ceramic may be contained in the heterogenous phase 29. However, it is preferable that the heterogenous phase 29 substantially contains no dielectric ceramic.

The heterogenous phase may be formed in a mode (i) in which it is formed in a firing step (S5) or in a mode (ii) in which it is formed in an additional step after a singulation step (S4), as will described later. In the mode (i), a component that can form the heterogenous phase (a heterogenous phase-forming component) is previously prepared in an internal electrode pattern, and the heterogenous phase-forming component is caused to seep out into the voids during the firing step (S5) and is caused to change to the heterogenous phase by cooling. In the mode (ii), the voids are filled with a material containing the heterogenous phase-forming component after the singulation step (S4), and the heterogenous phase-forming component is solidified in the subsequent firing step (S5) and is caused to change to the heterogenous phase. In the mode (i), the internal electrode layers 12 of the manufactured multilayer ceramic capacitor 10 contain a relatively large amount of the heterogenous phase-forming component. The heterogenous phase-forming component is a component that can form a glass phase, and may be at least silicon (Si).

The internal electrode layers 12 may contain silicon and may further contain aluminum. The internal electrode layers 12 may contain one or more selected from B, Mg, Mn, Ca, Sr, Na, K, Fe, Zr, Li, Zn, Pb, As, and Sb as elements other than silicon and aluminum.

When the internal electrode layers 12 contain silicon, the concentration of silicon (Si) in the internal electrode layers 12 measured in the center in the X direction is preferably 0.1atm% or greater and 20atm% or less, and more preferably 1atm% or greater and 10atm% or less.

The heterogenous phase-forming component may be contained not only in the internal electrode layers 12 but also in the dielectric layers 16. In this case, for example, the silicon concentration in the dielectric layers 16 may be 0.1atm% or greater and 10atm% or less.

In this specification, the concentration in the internal electrode layers 12 mentioned above is the concentration measured in the center of the internal electrode layers 12 in the X direction. The shape and dimensions of each element of the multilayer ceramic capacitor 10 can be known from a cross-section of the end margin part obtained from the multilayer ceramic electronic component, using a Transmission Electron Microscope (TEM), a Scanning Electron Microscope (SEM), and the like. The material of the heterogenous phase 29 in the voids 28 can be analyzed by elemental analysis using, for example, a Scanning Electron Microscope-Energy Dispersive X-ray analysis (SEM-EDS), an Electron Probe Micro-Analyzer (EPMA), and the like.

### Method for Manufacturing Multilayer Ceramic Electronic Component

Hereinafter, as a method for manufacturing a multilayer ceramic electronic component, the mode (i) in which the heterogenous phase is formed in the firing step will be mainly described.

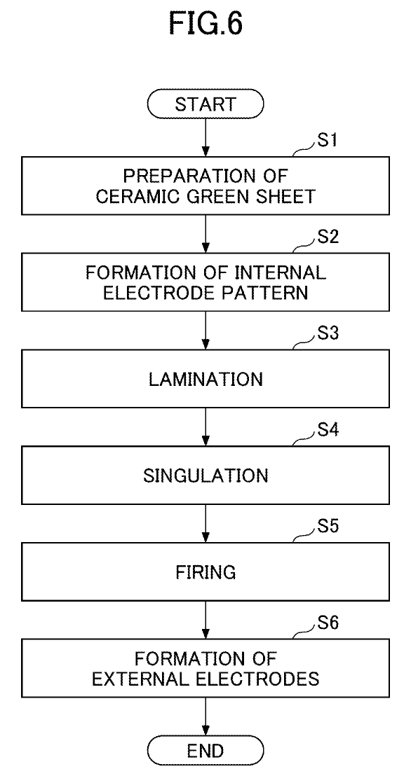

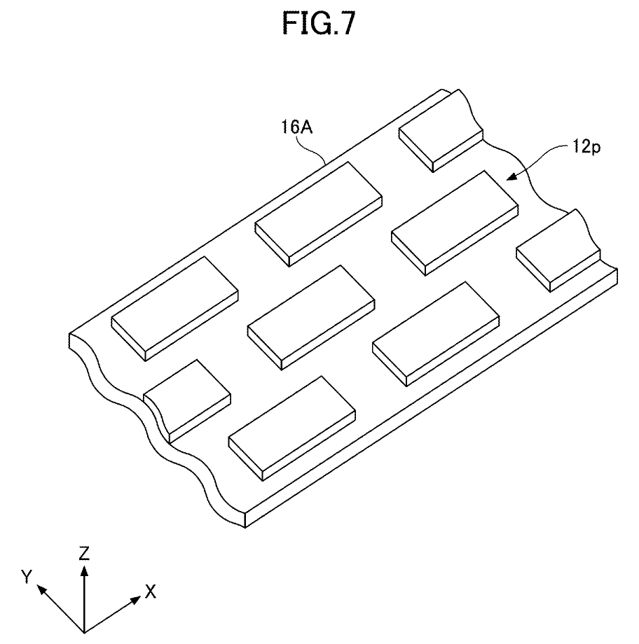

FIG. 6 is a flowchart showing a method for manufacturing a multilayer ceramic capacitor according to one embodiment. As shown in FIG. 6, the method for manufacturing a multilayer ceramic capacitor according to the embodiment includes a ceramic green sheet preparation step (S1) of preparing a ceramic green sheet, which becomes the dielectric layer 16, an internal electrode pattern formation step (S2) of forming an internal electrode pattern, which becomes the internal electrode layers 12, on the ceramic green sheet, a lamination step (S3) of laminating a plurality of ceramic green sheets each having an internal electrode pattern to obtain a laminate, a singulation step (S4) of singulating the laminate, a firing step (S5) of firing the singulated laminate, and an external electrode formation step (S6) of forming external electrodes.

### Ceramic Green Sheet Preparation Step (S1)

In the ceramic green sheet preparation step (S1), a plurality of ceramic green sheets 16A, which become the dielectric layers 16 in the multilayer ceramic capacitor 10 to be manufactured, are prepared. The ceramic green sheet 16A is an unfired sheet for forming a dielectric layer, containing a dielectric ceramic as a main component, and is composed of a material containing a dielectric ceramic powder. To obtain the dielectric green sheet, for example, a powder raw material is obtained by wet-mixing the dielectric ceramic powder while or without adding additives, such as a sintering aid and the like, and drying and grinding the resulting product. A binder, such as polyvinyl butyral (PVB) resin and the like, an organic solvent, such as ethanol, toluene, and the like, and a plasticizer are added to the powder raw material, and they are wet-mixed, to prepare a slurry. The slurry is then applied to a base material, such as a polyethylene terephthalate (PET) film and the like, by a die coater method, a doctor blade method, and the like, and dried. In this way, the ceramic green sheet can obtained. The ceramic green sheet 16A may be a large-sized ceramic green sheet from which a plurality of base bodies 11 can be obtained.

### Internal Electrode Pattern Formation Step (S2)

In the internal electrode pattern formation step (S2), as shown in FIG. 7, an internal electrode pattern 12p, which becomes the internal electrode layers 12 in the multilayer ceramic capacitor 10 to be manufactured, is formed on the ceramic green sheet 16A. The internal electrode pattern 12p may be formed by, for example, printing a conductive paste on the ceramic green sheet 16A. As shown in FIG. 7, the internal electrode pattern 12p is a pattern formed by printing the conductive paste discontinuously both in the X direction and the Y direction.

The conductive paste can be prepared by adding a resin, a solvent, and, if necessary, a plasticizer to a powder containing a metal or an alloy, which is the main component of the internal electrode layers 12 described above, and kneading them. In the present embodiment, the above-described heterogenous phase-forming component may be added to the conductive paste. The heterogenous phase-forming component is a component that can seep out from the conductive paste into a nearby space as a fluid, such as a liquid or a liquid-state component, at a high temperature, and can solidify as the heterogenous phase, preferably a glass phase, when cooled. The heterogenous phase-forming component is a component that can form a glass phase, and may be at least silicon (Si).

Therefore, the conductive paste may contain silicon, and may further contain aluminum (Al). The conductive paste may also contain one or more selected from B, Mg, Mn, Ca, Sr, Na, K, Fe, Zr, Li, Zn, Pb, As, and Sb as elements other than silicon and aluminum. Such a component as those above, that can form a glass phase may be added to the conductive paste in the form of an oxide powder.

When the conductive paste contains silicon, the concentration of silicon in the conductive paste is preferably 0.1atm% or greater and 20atm% or less, and more preferably 1atm% or greater and 10atm% or less. When the concentration of silicon is in the above range, an amount of the material that can sufficiently fill the voids can be supplied in the firing step (S5) described later, and the function as the conductive paste is not impaired as well.

The heterogenous phase-forming component, such as silicon and the like, may also be contained in the ceramic green sheet 16A in the above-described ceramic green sheet preparation step (S1). Thus, in the firing step (S5), the heterogenous phase forming material can be supplied not only from the conductive paste but also from the ceramic green sheet 16A.

### Lamination Step (S3)

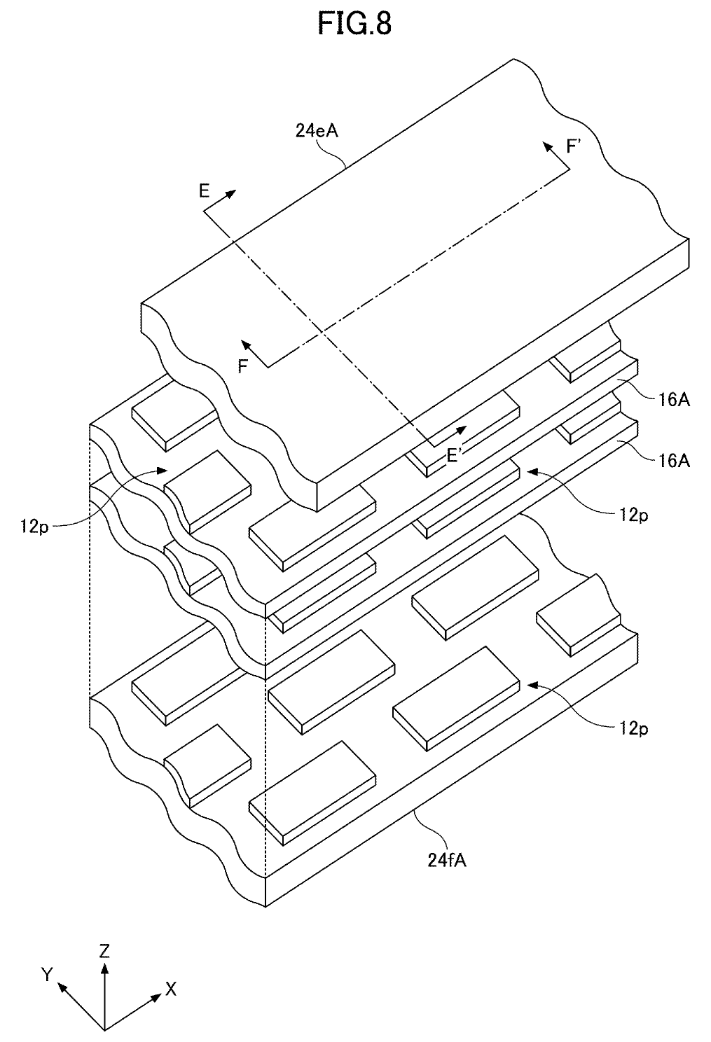

In the lamination step (S3), as shown in FIG. 8, a plurality of ceramic green sheets 16A, each having the internal electrode pattern 12p printed thereon, are laminated in the Z direction. The plurality of ceramic green sheets 16A are laminated such that the internal electrode patterns 12p adjacent to each other in the Z direction are staggered in the X direction. During lamination, a ceramic green sheet 24eA, which becomes the cover part 24e, may be disposed on the outermost side on the +Z side, and a ceramic green sheet 24fA, which becomes the cover part 24f, may be disposed on the outermost side on the −Z side.

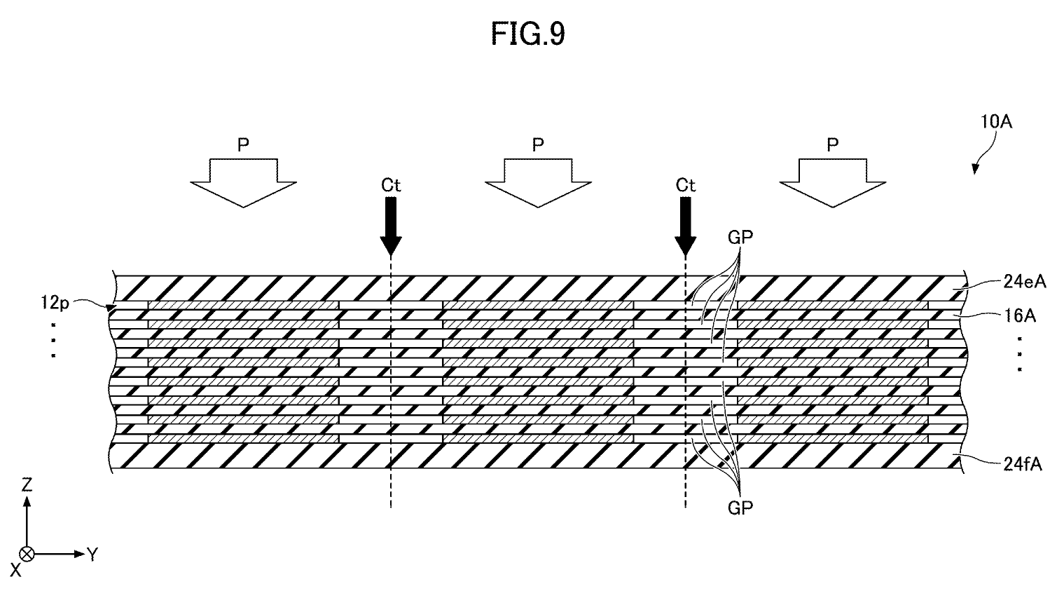

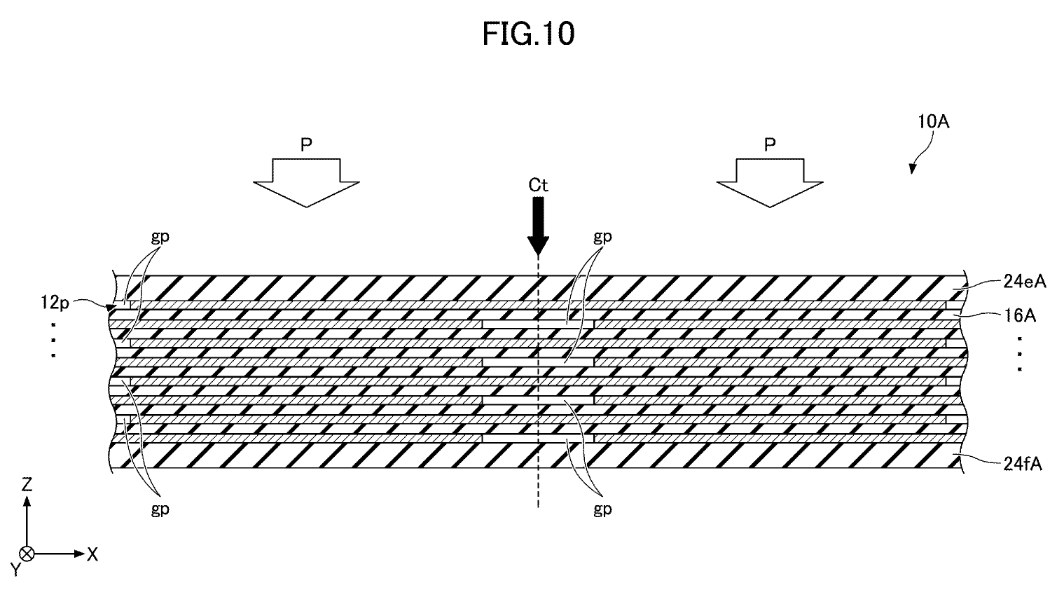

FIGS. 9 and 10 show cross-sectional views of a laminate 10A, in which the layers laminated as shown in FIG. 8 are brought into close contact with each other in the Z direction, taken along the lines E-E’ and F-F’. As shown in FIG. 10, the internal electrode patterns 12p adjacent to each other in the Z direction are staggered in the X direction. This staggering in the X direction is performed such that the first internal electrode layers 12a and the second internal electrode layers 12b are alternately exposed to the pair of end surfaces 11a and 11b of the base body 11 to be obtained.

As shown in FIG. 9, the internal electrode patterns 12p are patterns of the conductive paste printed discontinuously in the Y direction. In the present embodiment, no material is disposed between the printed conductive pastes when viewed in the Y direction. Therefore, gaps GP are formed between the ceramic green sheets 16A when viewed in the cross-section of the laminate 10A cut in the Y and Z directions.

Similarly, as shown in FIG. 10, the internal electrode patterns 12p are patterns of the conductive paste printed discontinuously in the X direction, and no material is disposed between the printed conductive pastes when viewed in the X direction. Therefore, gaps gp are formed between the ceramic green sheets 16A when viewed in the cross-section of the laminate 10A cut in the X and Z directions.

This method of forming the laminate without disposing any material between the conductive pastes is advantageous in that the process is not complicated and the cost can be saved because the method does not include formation of a step-offsetting member, such as a reverse pattern layer and the like.

From the state shown in FIGS. 9 and 10, pressure P is applied to the laminate in the Z direction to compression-bond the laminate. In this way, the laminate after being compression-bonded can be obtained. The pressure P may be applied uniformly to the entirety of the X-Y plane, or may be varied locally in the X-Y plane. Since the material of the ceramic green sheet protrudes into the gaps GP and gp through the compression-bonding, the shapes and sizes of the gaps GP and gp might change.

### Separation Step (S4)

In the singulation step (S4), the laminate after being compression-bonded is cut in the Z direction at predetermined positions, whereby the laminate can be singulated into a plurality of unfired base bodies. The predetermined cutting positions may be, for example, the cutting positions Ct shown in FIGS. 9 and 10. The unfired base bodies obtained by singulation are approximately rectangular parallelepiped. By cutting in the Y direction and the Z direction in the singulation step (S4), the ceramic green sheets 16A are joined in the Z direction at their ends in the X direction, and a pair of end surfaces facing each other in the X direction are formed. Similarly, by cutting in the X direction and the Z direction, the ceramic green sheets 16A are joined in the Z direction at their ends in the Y direction, and a pair of side faces facing each other in the Y direction are formed. Through the singulation step (S4), the voids 28 are formed in the parts of the base bodies 11 corresponding to the end margin parts 23a and 23b due to the gaps GP between the ceramic green sheets 16A. The state of the end margin parts of the unfired base bodies after the singulation step (S4) is similar to that of the configuration shown in FIG. 5.

The cutting method in the singulation step (S4) is not particularly limited, and it is possible to use pressure cutting by a cutter, dicing by a dicer, laser cutting, and the like.

### Firing Step (S5)

In the firing step (S5), the unfired base body is fired to obtain the base body 11. In the firing step (S5), the above-described heterogenous phase-forming component contained in the conductive paste seeps out as a fluid into the voids 28 from the conductive paste. Preferably, the entireties of the voids 28 are filled with a liquid or a liquid-state component automatically by capillary action. By cooling the base body 11 after firing, the liquid or the liquid-state component filled in the voids 28 solidifies to form the heterogenous phase 29 (FIG. 4).

The firing temperature in the firing step (S5) can be determined based on the sintering temperature of the dielectric ceramic material contained in the base body. For example, when a barium titanate-based material is used as the dielectric ceramic, the firing temperature can be approximately 1,000°C or higher and 1,300°C or lower. In this temperature range, the heterogenous phase-forming component seeps out into the voids 28 from the conductive paste favorably as well. The firing can be performed, for example, in a reducing atmosphere or a low oxygen partial pressure atmosphere.

### Formation of External Electrodes (S6)

The first external electrode 14 and the second external electrode 15 are formed by plating or the like on the pair of end surfaces 11a and 11b of the base body 11 obtained in the steps up to the firing step (S5). Thus, the multilayer ceramic capacitor 10 (FIGS. 1 to 3) is completed.

### Method for Manufacturing Multilayer Ceramic Electronic Component According to Modified Example

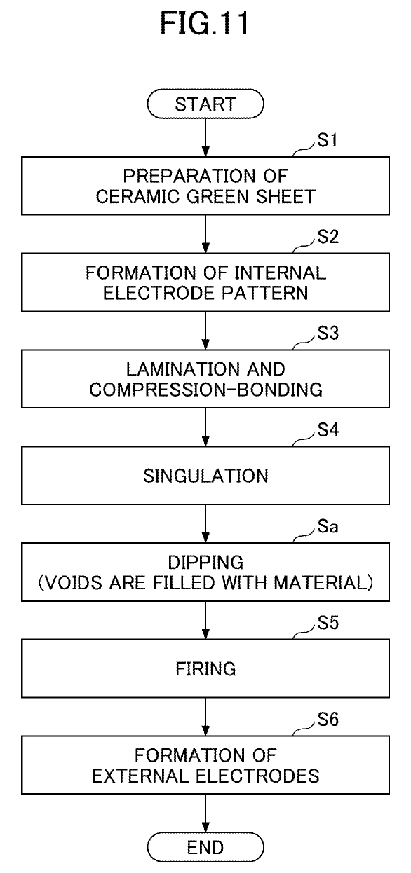

A modified example of the manufacturing method will be described. The manufacturing method according to the modified example is the mode (ii) in which the heterogenous phase 29 is formed in an additional step after the singulation step (S4). FIG. 11 shows a flowchart of the method for manufacturing a multilayer ceramic capacitor according to the modified example. The basic steps of the manufacturing method according to the modified example are the same as those of the manufacturing method according to the above-described mode (i) in which the heterogenous phase is formed in the firing step (S5), but are different in that the heterogenous phase-forming component is not blended in the conductive paste used in the internal electrode pattern formation step (S2), the heterogenous phase 29 is not formed in the firing step (S5), and the manufacturing method includes a dipping step (Sa) of dipping an unfired base body in a liquid containing the heterogenous phase-forming component after the singulation step (S4).

In the manufacturing method according to the present modified example, voids formed in an obtained unfired base body have remained unfilled through the singulation step (S4), and the end margin parts are, for example, in the state shown in FIG. 5. To handle this, in the dipping step (Sa), the method of the present example prepares a liquid containing the above-described heterogenous phase-forming component, more specifically, a component that can form a glass phase, and dips the unfired base body in the liquid to fill the voids in the unfired base body. Here, the liquid containing the heterogenous phase-forming component is a liquid containing silicon, may be a solution or a melt containing silicon, and may be, for example, a solution or a dispersion in which 0.1% by mass or greater and 10% by mass or less of a silane coupling agent or the like is dissolved or dispersed. The dipping step (Sa) may be performed in a vacuum environment to draw any gas from the voids in the unfired base body.

Although the multilayer ceramic capacitor 10 has been described as an example of the multilayer ceramic electronic component, the present disclosure is applicable to multilayer ceramic electronic components in general. Examples of such multilayer ceramic electronic components include a chip varistor, a chip thermistor, a multilayer inductor, and the like.

The above description of the present disclosure is based on embodiments. However, the present disclosure is not limited by these embodiments. Various modifications, corrections, replacements, addition, deletions, combinations, and the like are applicable to the above-described embodiments within the scope described in the claims, and are included in the technical scope of the present disclosure. The above-described components may be combined in any desirable manner.

Specific aspects of the present disclosure are, for example, as follows.

<1> A multilayer ceramic electronic component, including:

a base body including a plurality of dielectric layers laminated in a first direction and a plurality of internal electrode layers positioned between the plurality of dielectric layers, the base body having a pair of end surfaces facing each other in a second direction orthogonal to the first direction and a pair of side faces facing each other in a third direction orthogonal to the first direction and the second direction, the plurality of internal electrode layers being exposed to one and the other of the pair of end surfaces; and

external electrodes disposed on the pair of end surfaces, respectively,

wherein the base body includes end margin parts in which the internal electrode layers exposed to a same end surface face each other via none of the internal electrode layers exposed to a different end surface, and

wherein, in the end margin parts, the plurality of internal electrode layers include: a bent portion that is bent in the first direction; and a heterogenous phase that is composed of a material different from that of the plurality of dielectric layers and is in contact with the bent portion.

<2> The multilayer ceramic electronic component according to <1>,

wherein the bent portion includes a recessed portion recessed to one side or the other side in the first direction, and

the heterogenous phase contacts a bottom of the recessed portion.

<3> The multilayer ceramic electronic component according to <1> or <2>,

wherein the heterogenous phase contains glass as a main component.

<4> The multilayer ceramic electronic component according to any one of <1> to <3>,

wherein the heterogenous phase contains silicon and aluminum.

<5> The multilayer ceramic electronic component according to any one of <1> to <4>,

wherein the heterogenous phase has a silicon concentration of 1atm% or greater and 50atm% or less.

<6> The multilayer ceramic electronic component according to any one of <1> to <5>,

wherein the plurality of internal electrode layers contain silicon and have a silicon concentration of 0.1atm% or greater and 20atm% or less.

<7> The multilayer ceramic electronic component according to any one of <1> to <6>,

wherein an equivalent circle diameter of the heterogenous phase is 0.1 μm or greater and 10 μm or less when viewed in a cross-section along the first direction and the second direction.

<8> The multilayer ceramic electronic component according to any one of <1> to <7>,

wherein a length of the heterogenous phase in the third direction is equal to or greater than 3 times an equivalent circle diameter of the heterogenous phase when viewed in a cross-section along the first direction and the second direction.

<9> A method for manufacturing a multilayer ceramic electronic component, the method including:

forming internal electrode patterns, which become a plurality of internal electrode layers, respectively on a plurality of ceramic green sheets, which become a plurality of dielectric layers, by using a conductive paste containing 0.1atm% or greater and 20atm% or less of silicon;

laminating the plurality of ceramic green sheets in a first direction to obtain a laminate, wherein the laminate includes parts that become end margin parts and in which the ceramic green sheets and the internal electrode patterns facing the ceramic green sheets face each other via gaps;

singulating the laminate;

firing the singulated laminate to obtain a base body; and

forming external electrodes on a pair of end surfaces of the base body, respectively,

wherein the end margin parts, in which the internal electrode layers exposed to a same end surface face each other via none of the internal electrode layers exposed to a different end surface, are formed on both sides of the base body in a second direction orthogonal to the first direction, and

wherein, in the end margin parts, the plurality of internal electrode layers include: a bent portion that is bent in the first direction; and a heterogenous phase that is composed of a material different from that of the plurality of dielectric layers and is in contact with the bent portion.

What is claimed is:

1. A multilayer ceramic electronic component, comprising:
a base body including a plurality of dielectric layers laminated in a first direction and a plurality of internal electrode layers positioned between the plurality of dielectric layers, the base body having a pair of end surfaces facing each other in a second direction orthogonal to the first direction and a pair of side faces facing each other in a third direction orthogonal to the first direction and the second direction, the plurality of internal electrode layers being exposed to one and the other of the pair of end surfaces; and
external electrodes disposed on the pair of end surfaces, respectively,
wherein the base body includes end margin parts in which the internal electrode layers exposed to a same end surface face each other via none of the internal electrode layers exposed to a different end surface, and
wherein, in the end margin parts, the plurality of internal electrode layers include a bent portion that is bent in the first direction; and a heterogenous phase that is composed of a material different from that of the plurality of dielectric layers and is in contact with the bent portion.

2. The multilayer ceramic electronic component according to claim 1,
wherein the bent portion includes a recessed portion recessed to one side or the other side in the first direction, and
the heterogenous phase is in contact with a bottom of the recessed portion.

3. The multilayer ceramic electronic component according to claim 1,
wherein the heterogenous phase contains glass as a main component.

4. The multilayer ceramic electronic component according to claim 3,
wherein the heterogenous phase contains silicon and aluminum.

5. The multilayer ceramic electronic component according to claim 4,
wherein the heterogenous phase has a silicon concentration of 1atm% or greater and 50atm% or less.

6. The multilayer ceramic electronic component according to claim 1,
wherein the plurality of internal electrode layers contain silicon and have a silicon concentration of 0.1atm% or greater and 20atm% or less.

7. The multilayer ceramic electronic component according to claim 1,
wherein an equivalent circle diameter of the heterogenous phase is 0.1 μm or greater and 10 μm or less when viewed in a cross-section along the first direction and the second direction.

8. The multilayer ceramic electronic component according to claim 1,
wherein a length of the heterogenous phase in the third direction is equal to or greater than 3 times an equivalent circle diameter of the heterogenous phase when viewed in a cross-section along the first direction and the second direction.

9. A method for manufacturing a multilayer ceramic electronic component, the method comprising:
forming internal electrode patterns, which become a plurality of internal electrode layers, respectively on a plurality of ceramic green sheets, which become a plurality of dielectric layers, by using a conductive paste containing 0.1atm% or greater and 20atm% or less of silicon;
laminating the plurality of ceramic green sheets in a first direction to obtain a laminate, wherein the laminate includes parts that become end margin parts and in which the ceramic green sheets and the internal electrode patterns facing the ceramic green sheets face each other via gaps:
singulating the laminate;
firing the singulated laminate to obtain a base body; and
forming external electrodes on a pair of end surfaces of the base body, respectively,
wherein the end margin parts, in which the internal electrode layers exposed to a same end surface face each other via none of the internal electrode layers exposed to a different end surface, are formed on both sides of the base body in a second direction orthogonal to the first direction, and
wherein, in the end margin parts, the plurality of internal electrode layers include: a bent portion that is bent in the first direction; and a heterogenous phase that is composed of a material different from that of the plurality of dielectric layers and is in contact with the bent portion.
